(19) United States
(12) Patent Application Publication
(10) Pub. No.: US 2003/0110659 A1
(43) Pub. Date: Jun. 19, 2003

(54) Dryer device

(76) Inventors: Wolfgang Mohr, Halstenbek (DE); Nikolaus Groehl, Hamburg (DE)

Correspondence Address: Striker Striker & Stenby, 103 East Neck Road, Huntington, NY, 11743, US

(21) Appl. No.: 10/276,369

(22) PCT Filed: Apr. 6, 2001
(86) PCT No.: PCT/EP01/03979

(30) Foreign Application Priority Data
May 18, 2000 (DE) 100 24 099.2

(51) Int. Cl. F26B 3/34; F26B 13/10; F26B 19/00; F26B 9/00; F26B 13/00; F26B 13/06

(52) U.S. Cl. 34/266; 34/526; 34/618

(57) ABSTRACT

The invention relates to a dryer device for drying printing ink, lacquers or similar coatings. The aim of the invention is to improve a system comprising an electric emitter unit (1) mounted in a printing machine or the like for radiating sheets (2) or web material, with a high drying capacity while at the same time making sure that the surrounding machine parts are heated up as little as possible. To this end, the emitter unit (1) is provided with one or more rapidly starting IR medium-wave emitters (12), preferably IR carbon emitters (12) with a wavelength of radiation substantially in the range of from 2 μm to 3 μm.

The invention relates to a dryer device for drying printing ink, paints or similar coatings, having at least one electrical emitter unit that can be mounted in a printing press or the like, for irradiating printed sheets or web material.

Many dryer devices for fast drying of printing ink or the like are already known that, depending on the type of substance to be dried, utilize either the photochemical effect of UV emitters or the thermal radiation of IR emitters, or a combination of the two. In each case, the dryer devices, including the UV emitters, generate heat. Since printing presses are being made more and more compact, the dryer devices to be installed in the printing presses must also become more-compact, which increasingly presents problems in terms of dissipating the incident heat. From German Patent Disclosure DE 42 44 003 A1, a radiation dryer manifold is therefore known in which the rodlike IR emitter elements are cooled from the back side with cooling air that flows out of parallel rows of air dispensing nozzles.

The object of the invention is to disclose a dryer device of the type defined at the outset which while having high drying capacity brings about the least possible heating of the surrounding machine parts.

This object is attained according to the invention in that the emitter unit has one or more fast-starting IR medium-wave emitters.

Since the absorption ranges of conventional printing inks are in the medium-wave IR range, relatively good efficiency of the emitter unit is obtained, because the drying action of the medium-wave radiation is relatively high in comparison to the total quantity of heat dissipated. In this way, with high drying capacity, only relatively slight heating of the surrounding machine parts is achieved.

Conventional medium-wave IR emitters, for starting from a cold state until the requisite operating temperature for the drying process is reached, require times on the order of magnitude of some minutes. In the fast start, provided according to the invention, of the emitter, the ineffective length of time, during which it is already dissipating heat to the environment but has not yet reached the temperature required for the drying process, is reduced to some seconds. In a short starting process, less unnecessary heat in total is output to the environment. On average in terms of time, for a given drying capacity, a relatively lesser heating of the surrounding machine parts is thus achieved.

The dryer device of the invention is therefore suitable for installation in very compact printing presses, in which the machine components have a strong thermal effect on one another. It is also suitable for printing presses that because of the inks used, for instance in waterless offset printing, are very temperature-sensitive. They can also be installed in printing presses in which, because of the use of certain washing agents (such as type A2) with a low flash point of the solvent vapors, only considerably lower temperatures than in standard machines are permitted.

The drying capacity is optimized in proportion to the quantity of heat dispensed to the environment if the maximum radiation of the medium-wave emitter is in the wavelength range between 2 μm and 3 μm.

By using IR carbon emitters in the emitter unit, a medium-wave radiation characteristic with which very good efficiency can already be obtained is achieved in a simple way.

However, the efficiency of the emitter unit with carbon emitters can be still further improved by providing that the emitter unit is operated during the irradiation process at an electrical power that is slightly reduced compared to the usual electrical power. By this provision, the maximum intensity distribution is shifted still farther into the maximum absorption range of the printing inks, and thus the drying effect is improved further in proportion to the total quantity of heat dissipated.

In order to proceed faster, upon actuation of the emitter unit or on increasing the emission power, through the range of long-wave heat radiation that is less effective for the drying action, it is recommended that the emitter unit can be operated briefly at increased electrical power, for rapidly increasing the emission power. In this way, the efficiency of the dryer unit on average over time is improved, since the durations of the less-effective operating states are shortened.

By the provision that the dryer device includes a power regulator for regulating the emission power of the emitter unit, with at least one sensor for detecting at least one operating parameter that is dependent on the demand or effect of the emission power, and that the power regulator is embodied to increase the emission power to whatever value is required as a function of the operating parameter or parameters and at least partly to reduce it the rest of the time, the emission power of the emitter unit and/or its duration of action can be reduced to the applicable minimum required value, so that the product of the aforementioned variables, that is, the heat dissipated to the environment remains limited, from the very outset, to whatever is the least possible amount. Thus the heat dissipation to the environment can be reduced without lessening the drying capacity.

In a simple embodiment of the invention, it is provided that a value otherwise ascertained as optimal, in particular by means of previous experiments, for the emission power to be established during the irradiation is fixedly specified to the power regulator. Even this limitation in the emission power to the minimal value ascertained to be adequate as a rule for the individual case in question limits the total heat quantity dissipated.

The invention is still further improved, however, by the provision that at least one temperature sensor, connected to the power regulator, is provided for detecting the temperature of the irradiated sheet or web material, and the power regulator is embodied to regulate the emission power in such a way that a predetermined temperature value can be established at least approximately. In this way, whatever emission power is required can be adapted automatically to changing conditions, in particular to different absorption properties of the material to be dried or to changing ambient temperatures.

In a further feature of the concept of the invention, it is recommended that at least one temperature sensor, connected to the power regulator, is provided for detecting the temperature of certain regions of the printing press, and that the power regulator is embodied to reduce the emission power if a predetermined temperature value is exceeded. This provision prevents impairments from overheating to the operation of the printing press.

Unnecessary dissipation of heat to the environment can be reduced, during the time periods when there is no material to be dried located in the region of the emitter unit, by providing that a material sensor connected to the power regulator is provided for directly or indirectly detecting the presence of sheet or web material in the region of the emitter unit, and that the power regulator is embodied to increase the emission power in the presence of sheet or web material in the region of the emitter unit to whatever value is required and at least partly to lower it in the absence of them.

If the emitter unit has a substantially plane reflector baffle disposed downstream of the emitters, then the thermal radiation reflected by the material to be dried is reflected once again and thrown back onto the material to be irradiated. This increases the efficiency of the emitter unit still further, since even the radiation reflected by the material is not lost but instead increases the proportion of radiation that is effective with respect to the drying process.

In an economical embodiment that is simple to produce, the reflector baffle comprises aluminum.

A preferred refinement of the invention provides that air cooling is provided for the emitters; and that the reflector baffle is embodied as a cover baffle of a cooling air distribution manifold; and is equipped with hole-type nozzles for the passage therethrough of the cooling air to the emitters. Thus the reflector baffle, besides its function as a reflector, simultaneously acts as a cover baffle for the cooling air distribution shaft, thus advantageously making it possible not only to economize on material and reduce production costs but also to reduce the requisite installation space and make a more-compact structure possible. By means of the air cooling, the dissipation of the heat produced in the emitter unit is improved, which once again makes a more-compact structure possible.

The provision that the spacings between adjacent hole-type nozzles and/or the diameter of the holes of the hole-type nozzles is adapted approximately to the location-dependent distribution of air pressure in the cooling air distribution manifold, so that the emitters can be cooled as uniformly as possible everywhere, enables effective utilization of the available cooling air.

If extraction by suction of the heated air from the region of the emitter unit is provided, then the quantity of heat dissipated from the emitter unit to the ambient air is removed, along with the heated air, extensively from the interior of the printing press, making an even more-compact structure attainable without disadvantages.

In a further refinement of this concept, upstream and downstream of the emitter unit in terms of the direction of motion of the sheet or web material to be dried, respective air gaps are disposed in the cooling air distribution manifold, extending transversely to the direction of motion essentially over the entire dimension of the emitter unit. The air flowing out of the aforementioned air gaps generates a barrier to the heated air on both sides of the emitter unit, and this heated air is thus unable to penetrate adjacent regions of the printing press and is extracted completely by suction.

Moreover, this provision has the advantage that air from the other regions of the printing press, which as a rule is laden with dust, cannot penetrate the region of the emitter unit. This prevents the emitter unit from being soiled with dirt particles and especially powder from a powder device of the printing press.

If a shielding baffle is disposed between the emitter unit and adjacent parts of the printing press, then the thermal radiation output from the emitter unit to the rear cannot reach the machine parts, and thus these parts remain cooler. In addition, the shielding baffle can be provided, on its side toward the emitter unit, with a thermal insulation, in order to reduce the transfer of heat from the shielding baffle to the machine parts.

One exemplary embodiment of the invention is described in detail below in conjunction with the drawings. Individually, the drawings show:

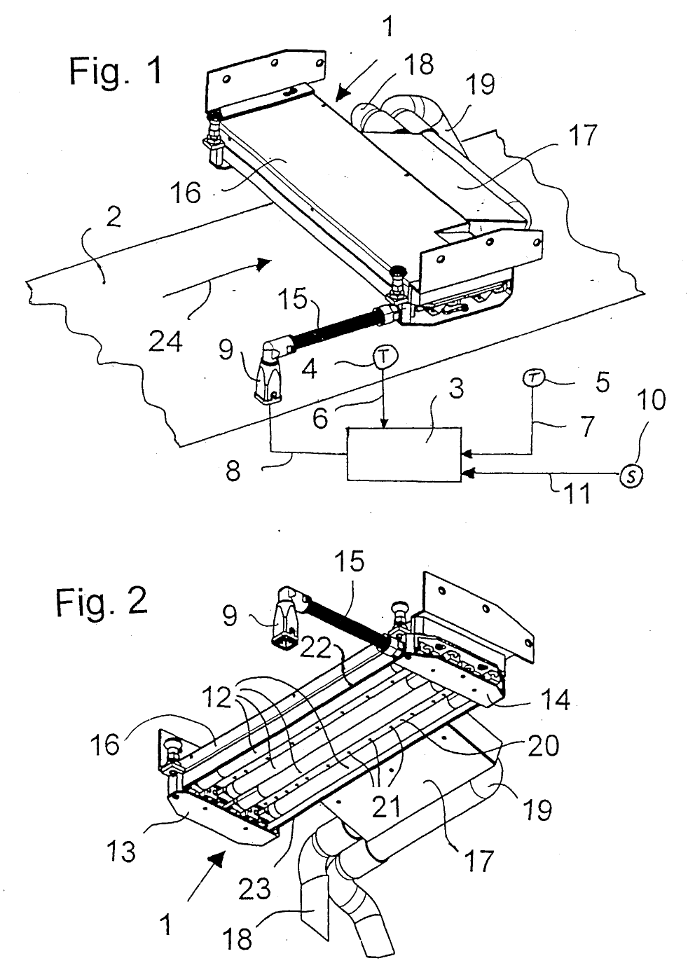

FIG. 1: a dryer device of the invention, seen partly in a perspective view obliquely from above and partly schematically;

FIG. 2: an emitter unit of the dryer device, in a perspective view obliquely from below;

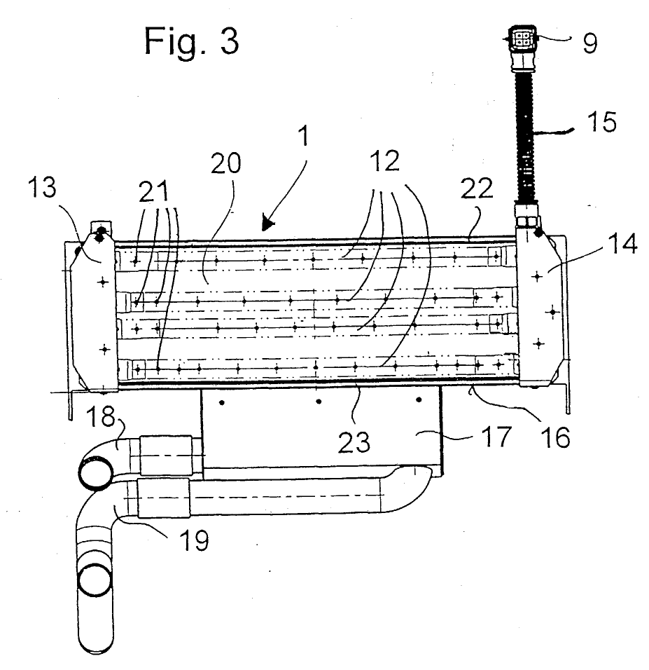

FIG. 3: a view of the underside of the same emitter unit.

In the drawings, an emitter unit 1 of a dryer device intended for installation in a printing press, not shown, can be seen in particular.

The printing press is one intended for waterless offset printing and is itself relatively small and compact in structure. Since the installation conditions in the printing press are very tight, the emitter unit 1 is designed quite compactly and is adapted precisely to the only slight installation space available. The printing press is already quite temperature-sensitive, because of its compact structure and the waterless offset printing technique. A further factor is that it can be cleaned only with a type A2 washing agent, which has a low flash point. Because of the resultant sensitivity to emissions of solvent vapors, only considerably lower temperatures than in conventional standard printing presses are allowed.

Under the aforementioned circumstances, it is especially important that the dryer device dissipate as little heat as possible to the printing press. This problem is solved by the invention on the one hand by providing that as little heat as possible is generated, and on the other that penetration of the heat generated by the emitter unit 1 into other regions of the printing press is prevented, and the heat is dissipated quickly and effectively.

The emitter unit 1 is intended for irradiating printed sheets 2, which travel through the printing press and move past and underneath the emitter unit 1. As can be seen from the schematic illustration in FIG. 1, the dryer device also includes a power regulator 3, a temperature sensor 4 for detecting the temperature prevailing at the sheet 2, and a temperature sensor 5 for measuring the temperature of the printing press at a point that is especially sensitive to overheating. The temperature sensors 4, 5 are connected via signal lines 6, 7 to the power regulator 3, which in turn regulates the electrical power reaching the emitter unit 1 via a supply line 8 and a plug connector 9. Also connected to the power regulator 3 is a material sensor 10, via a signal line 11. With the aid of the material sensor 10, it can be detected whether or not sheets 2 to be irradiated are located in the region of the emitter unit 1. The material sensor 10 can for instance be embodied as a photoelectric sensor, motion sensor, or simple electrical contact, or else the requisite signal is derived from sensors of the printing press that are already present, or from their operating states, for instance from the supply voltage of motors or other electrical components.

Thus parameters of the printing press are detected by means of the sensors 4, 5, 10. The material sensor 11 reports the demand for irradiation, when the material to be irradiated reaches the region of the emitter unit 1. Depending on the temperature of the material to be irradiated, the temperature sensor 4 can signal a greater or lesser demand for irradiation. The temperature sensor 5 indicates when the irradiation capacity has caused impermissible heating of vulnerable parts of the printing press. In every case, there is a demand for regulation, and the power regulator then regulates the electrical power flowing into the emitter unit 1, and thus the output emission power, upward or downward in accordance with specified regulation mechanisms, preferably by means of a programmable microprocessor. In this way, the quantity of heat output by the emitter unit 1 can be reduced at least on average over time, without undershooting the minimum emission power required for the irradiation. Thus at least on average over time, the ratio of the usable radiation quantity to the total quantity of heat output is increased, which improves the defined efficiency of the dryer device.

As can be seen best from FIGS. 2 and 3, the emitter unit 1 is equipped with four carbon emitter tubes 12, which are indicated only by dashed lines in FIG. 3. These are quartz tubes, in each of which a carbon band approximately 1 cm wide is placed. The ends of the tubes are closed and provided with electrical contacts, by way of which a flow of current through the carbon band can be brought about. As a rule, the quartz tubes are provided with a vapor-deposited gold coating on one side, which in operation is disposed on the back, and this prevents the escape of IR radiation at the back.

Carbon emitters are especially well suited for IR drying of the printing inks used here, because their maximum radiation spectrum is located in the medium-wave infrared range and thus covers the essential absorption ranges of the printing inks to be dried. The aforementioned efficiency of carbon emitters for the purposes described is therefore higher than that of other IR emitters that have incandescent wire. The aforementioned efficiency can be improved still further if the carbon emitters, in the irradiation process, are operated at somewhat reduced power compared to their rated power. Conversely, by means of a briefly increased power during the heating process that is not usable for the drying process, a further increase in efficiency on average over time can be attained, because the heating process is thus shortened, and the heat dissipation during the time that is not available for the drying process is reduced.

The carbon emitters 12 are secured in special retainers 13, 14 on a cooling air distribution manifold 16 and are disposed transversely to the feeding direction of the material 2 to be irradiated. In the retainer 14, the carbon emitters 12 are connected to a connection cable 15, which ends in a plug connector 9 that can be connected to the supply line 8.

The cooling air distribution manifold 16 essentially comprises an approximately block-shaped metal box, which is disposed above the carbon emitters 12 and is connected to a somewhat smaller, likewise box-shaped antechamber 17. Between the antechamber 17 and the cooling air distribution manifold 16, holes, not shown, for the passage of cooling air are provided. The cooling air comes from a blower, not shown, and reaches the antechamber 17 via two delivery tubes 18, 19 discharging at different points into the antechamber 17, where the cooling air is distributed and flows into the cooling air distribution manifold 16 via the holes, not shown.

The underside of the cooling air distribution manifold 16 is closed with a cover baffle 20 of aluminum, which serves on the one hand as a reflector for the IR radiation thrown back from the irradiated material 2 and on the other as a carrier for many hole-type nozzles 21 that are intended for the passage through them of the cooling air. The cooling air emerges from the hole-type nozzles 21 and strikes the carbon emitters 12, which are thus cooled.

To achieve the most uniform possible cooling of the carbon emitters 12, the hole-type nozzles 21 are disposed in four rows along the carbon emitters 12. Within one row, the spacings of the hole-type nozzles 21 are least in the regions where the least air pressure prevails inside the cooling air distribution manifold 16. In regions with a higher air pressure, the hole-type nozzles 21 have greater spacings. This establishes an equalization, so that the carbon emitters 12 are bathed with essentially equal quantities of air over their entire length and are simultaneously cooled.

In order for the heated air to be removed as effectively as possible from the region of the emitter unit 1 without reaching adjacent regions of the printing press and being able to heat it, a suction extractor, not shown, is provided, which is reinforced by air guide baffles, also not shown. A shielding baffle, not shown, for shielding off the adjacent machine parts from the thermal radiation is also provided above the emitter unit 1 and is additionally provided with a thermal insulation on its side remote from the thermal radiation.

On the cooling air distribution manifold 16, there is a respective air gap 22, 23 disposed upstream and downstream of the emitter unit 1 in terms of the direction of motion 24 of the irradiated material 2. The air gaps 22, 23 extend transversely over the entire dimension of the emitter unit 1 and thus each generate a closed curtain of air, by which the region of the emitter unit 1 is partitioned off in such a way that hot air cannot reach other regions of the printing press, nor can contaminants, especially powder from a powder station, or combustible solvent vapors from other regions of the printing press, reach the region of the emitter unit 1.

Because of the described automation of the drying process, optimal production conditions can always be maintained. Because of the compact structure of the emitter unit 1 of the invention, numerous advantages, in particular simple handling for service and maintenance purposes, little requirements for space, a long life, simple installation, and good suitability for retrofitting, are obtained.

### List of Reference Numerals

1 Emitter unit

2 Sheet

3 Power regulator

4 Temperature sensor

5 Temperature sensor

6 Signal line

7 Signal line

8 Supply line

9 Plug connector

10 Material sensor

11 Signal line

12 Carbon emitter

13 Retainer

14 Retainer

15 Connection cable

16 Cooling air distribution manifold

17 Antechamber

18 Delivery tube

19 Delivery tube

20 Cover baffle/reflector baffle

21 Hole-type nozzles

22 Air gap

23 Air gap

24 Direction of motion

1. A dryer device for drying printing ink, paints or similar coatings, having at least one electrical emitter unit (1) that can be mounted in a printing press or the like, for irradiating printed sheets (2) or web material, characterized in that the emitter unit (1) has one or more fast-starting IR medium-wave emitters (12).

2. The dryer device of claim 1, characterized in that the maximum radiation of the medium-wave emitter (12) is in the wavelength range between 2 μm and 3 μm.

3. The dryer device of claim 1 or 2, characterized in that the emitter unit (1) is equipped with IR carbon emitters (12).

4. The dryer device of one of the foregoing claims, characterized in that the emitter unit (1) is operated during the irradiation process at an electrical power that is slightly reduced compared to the usual electrical power.

5. The dryer device of one of the foregoing claims, characterized in that the emitter unit (1) can be operated briefly at increased electrical power, for rapidly increasing the emission power.

6. The dryer device of one of the foregoing claims, characterized in that the dryer device includes a power regulator (3) for regulating the emission power of the emitter unit (1), with at least one sensor (4, 5, 10) for detecting at least one operating parameter that is dependent on the demand or effect of the emission power, and that the power regulator (3) is embodied to increase the emission power to whatever value is required as a function of the operating parameter or parameters and at least partly to reduce it the rest of the time.

7. The dryer device of claim 6, characterized in that a value otherwise ascertained as optimal, in particular by means of previous experiments, for the emission power to be established during the irradiation is fixedly specified to the power regulator (3).

8. The dryer device of claim 6, characterized in that at least one temperature sensor (4), connected to the power regulator (3), is provided for detecting the temperature of the irradiated sheet material (2) or web material, and the power regulator (3) is embodied to regulate the emission power in such a way that a predetermined temperature value can be established at least approximately.

9. The dryer device of one of claims 6-8, characterized in that at least one temperature sensor (5), connected to the power regulator (3), is provided for detecting the temperature of certain regions of the printing press, and that the power regulator (3) is embodied to reduce the emission power if a predetermined temperature value is exceeded.

10. The dryer device of one of claims 6-9, characterized in that a material sensor (10) connected to the power regulator (3) is provided for directly or indirectly detecting the presence of sheet material (2) or web material in the region of the emitter unit (1), and that the power regulator (3) is embodied to increase the emission power in the presence of sheet material (2) or web material in the region of the emitter unit (1) to whatever value is required and at least partly to lower it in the absence of them.

11. The dryer device of one of the foregoing claims, characterized in that the emitter unit (1) has a substantially plane reflector baffle (20) disposed downstream of the emitters (12).

12. The dryer device of claim 11, characterized in that the reflector baffle (20) comprises aluminum.

13. The dryer device of claim 11 or 12, characterized in that air cooling is provided for the emitters (12); and that the reflector baffle is embodied as a cover baffle (20) of a cooling air distribution manifold (16); and is equipped with hole-type nozzles (21) for the passage therethrough of the cooling air to the emitters (12).

14. The dryer device of claim 13, characterized in that the spacings between adjacent hole-type nozzles (21) and/or the diameter of the holes of the hole-type nozzles (21) is adapted approximately to the location-dependent distribution of air pressure in the cooling air distribution manifold (16), so that the emitters (12) can be cooled as uniformly as possible everywhere.

15. The dryer device of claim 13 or 14, characterized in that extraction by suction of the heated air from the region of the emitter unit (1) is provided.

16. The dryer device of one of the foregoing claims, characterized in that upstream and downstream of the emitter unit (1) in terms of the direction of motion (24) of the sheet material (2) or web material to be dried, respective air gaps (22, 23) are disposed in the cooling air distribution manifold (16), extending transversely to the direction of motion (24) essentially over the entire dimension of the emitter unit (1).

17. The dryer device of one of the foregoing claims, characterized in that a shielding baffle is disposed between the emitter unit (1) and adjacent parts of the printing press.

18. The dryer device of claim 17, characterized in that the shielding baffle is provided, on its side toward the emitter unit (1), with a thermal insulation.
